(19) United States
(12) Patent Application Publication
(10) Pub. No.: US 2014/0204014 A1
(43) Pub. Date: Jul. 24, 2014

(54) OPTIMIZING SELECTION OF A MEDIA OBJECT TYPE IN WHICH TO PRESENT CONTENT TO A USER OF A DEVICE

(71) Applicant: Ola Thorn, Lund (SE)

(72) Inventor: Ola Thorn, Lund (SE)

(73) Assignee: SONY MOBILE COMMUNICATIONS AB, Lund (SE)

(21) Appl. No.: 13/823,154

(22) PCT Filed: Mar. 30, 2012
(86) PCT No.: PCT/IB12/00649

§ 371 Date: Mar. 14, 2013

(51) Int. Cl. G06F 3/01

(52) U.S. Cl. CPC G06F 3/01
USPC 345/156

(57) ABSTRACT

A system for optimizing selection of a media object type in which to present content to a user of the device includes a display configured to reproduce visual media type objects associated with the content, a speaker configured to reproduce audio media type objects associated with the content, a detection logic configured to detect whether the user is paying attention to a portion of the display, and a processor configured to determine a media object to present to the user of the device from a selection of media objects including media objects of several different media object types based on whether the user is paying attention to the portion of the display.

### TECHNICAL FIELD OF THE INVENTION

The technology of the present disclosure relates generally to electronic devices and, more particularly, to electronic devices capable of playing media content.

### BACKGROUND

Mobile and wireless electronic devices are becoming increasingly popular. For example, mobile telephones, portable media players, and portable gaming devices are now in widespread use. In addition, the features associated with these electronic devices have become increasingly diverse. To name a few examples, many electronic devices have cameras, media playback capability (including audio and/or video playback), image display capability, video game playing capability, and Internet browsing capability. In addition, many more traditional electronic devices such as televisions also now include features such as Internet browsing capability.

A large part of the Internet as well as other media such as television is funded by advertising. As video usage by users of electronic devices such as computers, mobile devices and televisions has exploded, video ads have become more and more important. Techniques conventionally employed to coerce users into watching video ads include: playing a video ad before a movie or show begins playing, playing a video ad or banner in the layout around the movie or show, and product placement (e.g., showing products or services within the movie or show).

However, these conventional techniques maybe of annoyance to a user (e.g., making people have to watch a video ad before a movie or show begins playing may cause people not to watch the movie or show, video or banners in the layout around the movie or show disturb the viewing experience, etc.)

### SUMMARY

To facilitate user consumption of advertising content, among other applications, the present disclosure describes improved systems, devices, and methods for optimizing the selection of a media object type in which to present content to a user of a device.

According to one aspect of the invention, a method for optimizing selection of a media object type in which to present content to a user of a device includes playing a visual media object associated with the content, detecting whether the user is paying attention to a portion of a screen of the device where the visual media object is playing, and performing at least one of the following based on whether the user is paying attention to the portion of the screen of the device: 1) continue playing the visual media object if the user is paying attention to the portion of the screen of the device, or 2) playing an audio media object associated with the content if the user is not paying attention to the portion of the screen of the device.

In one embodiment, the detecting whether the user is paying attention to the portion of the screen of the device includes performing at least one of: eye tracking, face detection, tremor detection, capacitive sensing, receiving a signal from an accelerometer, detecting minimization of an application screen, heat detection, receiving a signal from a device configured to perform galvanic skin response (GSR), and detecting whether a screen saver is activated.

In one embodiment, the method includes receiving text data representing a message associated with the content, and transforming the text data into the audio media object.

In one embodiment, the performing includes transmitting real time streaming protocol (RTSP) requests, such that the performing occurs substantially in real time.

In one embodiment, the playing the visual media object associated with the content includes at least one of playing a video media object associated with the content, and displaying an image media object associated with the content.

In one embodiment, the playing the audio media object associated with the content includes at least one of playing an audio media object including a spoken-voice message associated with the content, playing an audio media object including a jingle message associated with the content, and playing a soundtrack.

In one embodiment, in preparation for playing the visual media object associated with the content, the method includes detecting whether the user is paying attention to the portion of the screen of the device, determining whether to play the visual media object based on whether the user is paying attention to the portion of the screen of the device, and determining whether to play the audio media object based on whether the user is paying attention to the portion of the screen of the device.

According to another aspect of the invention, a method for optimizing a media object type in which to present content to a user in a device includes, in preparation for displaying of a media object, detecting whether the user is paying attention to a portion of a screen of the device, and determining a media object type to present to the user from a selection of media objects including media objects of several different media object types based on whether the user is paying attention to the portion of the screen of the device.

In one embodiment, the determining determines a visual media object type to be displayed from the selection of media objects including media objects of several different media object types based on the user being detected paying attention to the portion of the screen of the device, the method further comprising playing a visual media object type media object associated with the content, detecting whether the user is paying attention to a portion of the screen of the device where the visual media object type media object associated with the content is playing, and performing one of the following based on whether the user is paying attention to the portion of the screen of the device where the visual media object type media object associated with the content is playing: continue playing the visual media object type media object associated with the content if the user is paying attention to the portion of the screen of the device where the visual media object type media object associated with the content is playing, and playing an audio media object type media object associated with the content if the user is not paying attention to the portion of the screen of the device where the visual media object type media object associated with the content is playing.

In one embodiment, the playing the audio media object type media object includes: receiving text data representing a message associated with the content, and transforming the text data into the audio media object type media object.

In one embodiment, the receiving the text data representing the message associated with the content includes receiving the text data in a first language, and the transforming the text data into the audio media object type media object includes transforming the text data into the audio media object type media object, wherein the audio media object type media object is in a second language different from the first language.

In one embodiment, the detecting step includes performing at least one of eye tracking, face detection, tremor detection, capacitive sensing, receiving a signal from an accelerometer, detecting minimization of an application screen, heat detection, receiving a signal from a device configured to perform galvanic skin response (GSR), and detecting whether a screen saver is activated.

In one embodiment, the performing comprises transmitting real time streaming protocol (RTSP) requests, such that the performing occurs substantially in real time.

In one embodiment, the playing the audio media object type media object associated with the content includes at least one of playing a first media object including a spoken-voice message associated with the content, playing a second media object including a jingle message associated with the content, and playing a soundtrack.

According to yet another aspect of the invention, a system for optimizing selection of a media object type in which to present content to a user of the device includes a display configured to reproduce visual media type objects associated with the content, a speaker configured to reproduce audio media type objects associated with the content, a detection logic configured to detect whether the user is paying attention to a portion of the display, and a processor configured to determine a media object to present to the user of the device from a selection of media objects including media objects of several different media object types based on whether the user is paying attention to the portion of the display.

In one embodiment, the processor is configured to determine to present or continue to present to the user a visual media type object associated with the content if the user is paying attention to the portion of the display, and wherein the processor is configured to determine to present to the user an audio media type object associated with the content if the user is not paying attention to the portion of the display.

In one embodiment, the method comprises a text-to-speech logic configured to receive text data representing a message associated with the content and further configured to transform the text data into the audio media type object.

In one embodiment, the text-to-speech logic is configured to receive the text data representing the message associated with the content in a first language and to transform the text data into the audio media type object, wherein the audio media object type media object is in a second language different from the first language.

In one embodiment, the detection logic is configured to perform at least one of eye tracking, face detection, tremor detection, capacitive sensing, receiving a signal from an accelerometer, detecting minimization of an application screen, heat detection, receiving a signal from a device configured to perform galvanic skin response (GSR), and detecting whether a screen saver is activated.

In one embodiment, the processor is configured to instruct the performing of the determined media object at least in part by transmitting real time streaming protocol (RTSP) requests, such that the performing occurs substantially in real time.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 illustrates an operational environment including an electronic device.

FIG. 2 illustrates a block diagram of an exemplary system for optimizing selection of a media object type in which to present content to a user of the device.

FIG. 3 shows a flowchart that illustrates logical operations to implement an exemplary method for optimizing selection of a media object type in which to present content to a user of a device.

FIG. 4 shows a flowchart that illustrates logical operations to implement another exemplary method for optimizing selection of a media object type in which to present content to a user of a device.

### DETAILED DESCRIPTION OF EMBODIMENTS

Embodiments will now be described with reference to the drawings, wherein like reference numerals are used to refer to like elements throughout. It will be understood that the figures are not necessarily to scale.

In the present disclosure, embodiments are described primarily in the context of a mobile telephone. It will be appreciated, however, that the exemplary context of a mobile telephone is not the only operational environment in which aspects of the disclosed systems and methods may be used. Therefore, the techniques described in this disclosure may be applied to any type of appropriate electronic device, examples of which include a mobile telephone, a media player, a gaming device, a computer, a television, a video monitor, a multimedia player, a DVD player, a Blu-Ray player, a pager, a communicator, an electronic organizer, a personal digital assistant (PDA), a smartphone, a portable communication apparatus, etc.

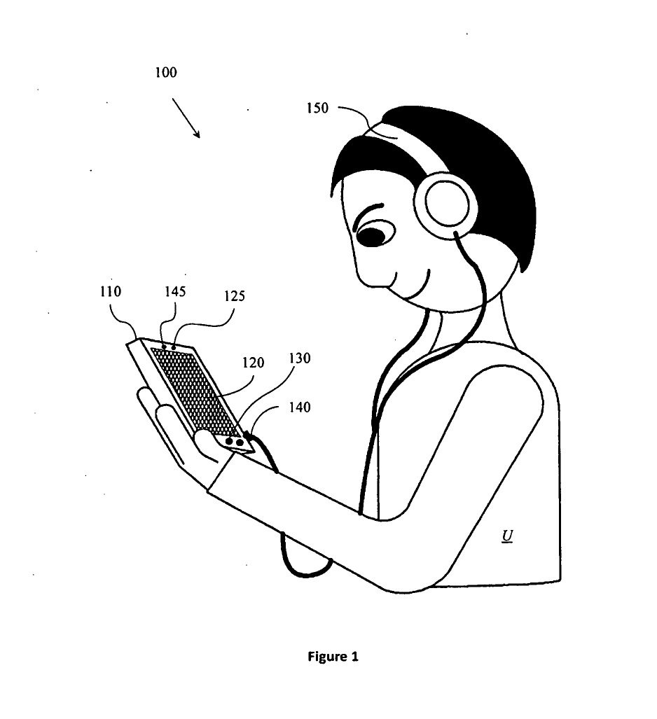

FIG. 1 illustrates an operational environment 100 including an electronic device 110. The electronic device 110 of the illustrated embodiment is a mobile telephone that is shown as having a “brick” or “block” form factor housing, but it will be appreciated that other housing types may be utilized, such as a “flip-open” form factor (e.g., a “clamshell” housing) or a slide-type form factor (e.g., a “slider” housing).

The electronic device 110 includes a display 120. The display 120 displays information to a user U, such as operating state, time, telephone numbers, contact information, various menus, etc., that enable the user U to utilize the various features of the electronic device 110. The display 120 may also be used to visually display content received by the electronic device 110 or content retrieved from memory of the electronic device 110. The display 120 may be used to present images, video, and other visual media type objects to the user U, such as photographs, mobile television content, and video associated with games, and so on.

The electronic device 110 includes a speaker 125 connected to a sound signal processing circuit (not shown) of the electronic device 110 so that audio data reproduced by the sound signal processing circuit may be output via the speaker 125. The speaker 125 reproduces audio media type objects received by the electronic device 110 or retrieved from memory of the electronic device 110. The speaker 125 may be used to reproduce music, speech, etc. The speaker 125 may also be used in conjunction with the display 120 to reproduce audio corresponding to visual media type objects such as video, images, or other graphics such as photographs, mobile television content, and video associated with games presented to the user U on the display 120. In one embodiment, the speaker 125 corresponds to multiple speakers.

The electronic device 110 further includes a keypad 130 that provides for a variety of user input operations. For example, the keypad 130 may include alphanumeric keys for allowing entry of alphanumeric information such as telephone numbers, phone lists, contact information, notes, text, etc. In addition, the keypad 130 may include special function keys such as a “call send” key for initiating or answering a call and a “call end” key for ending or “hanging up” a call. Special function keys also may include menu navigation keys, for example, to facilitate navigating through a menu displayed on the display 120. For instance, a pointing device or navigation key may be present to accept directional inputs from a user U, or a select key may be present to accept user selections.

Special function keys may further include audiovisual content playback keys to start, stop, and pause playback, skip or repeat tracks, and so forth. Other keys associated with the electronic device 110 may include a volume key, an audio mute key, an on/off power key, a web browser launch key, etc. Keys or key-like functionality also may be embodied as a touch screen associated with the display 120. Also, the display 120 and keypad 130 may be used in conjunction with one another to implement soft key functionality.

The electronic device 110 may further include one or more I/O interfaces such as interface 140. The I/O interface 140 may be in the form of typical electronic device I/O interfaces and may include one or more electrical connectors. The I/O interface 140 may serve to connect the electronic device 110 to an earphone set 150 (e.g., in-ear earphones, in-concha earphones, over-the-head earphones, personal hands free (PHF) earphone device, and so on) or other audio reproduction equipment that has a wired interface with the electronic device 110. In one embodiment, the I/O interface 140 serves to connect the earphone set 150 to a sound signal processing circuit of the electronic device 110 so that audio data reproduced by the sound signal processing circuit may be output via the I/O interface 140 to the earphone set 150.

The electronic device 110 also may include a local wireless interface (not shown), such as an infrared (IR) transceiver or a radio frequency (RF) interface (e.g., a Bluetooth interface) for establishing communication with an accessory, another mobile radio terminal, a computer, or another device. For example, the local wireless interface may operatively couple the electronic device 110 to the earphone set 150 or other audio reproduction equipment with a corresponding wireless interface.

Similar to the speaker 125, the earphone set 150 may be used to reproduce audio media type objects received by the electronic device 110 or retrieved from memory of the electronic device 110. The earphone set 150 may be used to reproduce music, speech, etc. The earphone set 150 may also be used in conjunction with the display 120 to reproduce audio corresponding to video, images, or other graphics such as photographs, mobile television content, and video associated with games presented to the user U on the display 120.

The electronic device 110 further includes a camera 145 that may capture still images or video. The electronic device 110 may further include an accelerometer (not shown).

The electronic device 110 is a multi-functional device that is capable of carrying out various functions in addition to traditional electronic device functions. For example, the exemplary electronic device 110 also functions as a media player. More specifically, the electronic device 110 is capable of playing different types of media objects such as audio media object types (e.g., MP3, .wma, AC-3, etc.), visual media object types such as video files (e.g., MPEG, .wmv, etc.) and still images (e.g., .pdf, JPEG, .bmp, etc.). The electronic device 110 is also capable of reproducing video or other image files on the display 120 and capable of sending signals to the speaker 125 or the earphone set 150 to reproduce sound associated with the video or other image files, for example.

In one embodiment, the device 110 is configured to detect whether the user U is paying attention to a portion of the display 120 where a visual media type object is playing or may be about to be played. The device 110 may further determine a media object to present to the user U from a selection of media objects including media objects of several different media object types based on whether the user U is paying attention to the portion of the display 120.

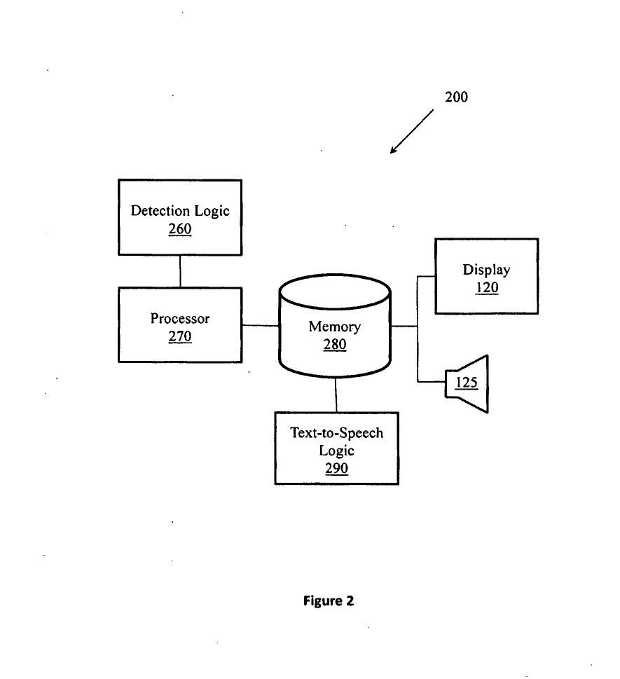

FIG. 2 illustrates a block diagram of an exemplary system 200 for optimizing selection of a media object type in which to present content to a user of the device 110. The system 200 includes a display 120 configured to reproduce visual media type objects associated with content. Visual media type objects include still images, video, graphics, photographs, mobile television content, advertising content, movies, video associated with games, and so on. The system 200 further includes speaker 125. The speaker 125 reproduce audio media type objects associated with the content. Audio media type objects include music, speech, etc. The display 120 and the speaker 125 may be used in conjunction to reproduce visual media objects and audio media objects associated with the content. For example, in an advertisement, the display 120 may display video associated with the advertisement while the speaker 125 reproduces audio corresponding to the video. In one embodiment, where the device 110 is used in conjunction with the earphones 150, the earphones 150 may operate in place of or in conjunction with the speaker 125.

The system 200 further includes a detection logic 260. The detection logic 260 detects whether the user U is paying attention to a portion of the display 120. The portion of the display 120 may correspond to an area of the display 120 where a visual media type object (e.g., a video) is playing.

In one embodiment, the detection logic 260 performs eye tracking to determine whether the user U is paying attention to the portion of the display 120. Eye tracking is a technique that determines the point of gaze (i.e., where the person is looking) or the position and motion of the eyes. For example, the system 200 may make use of the camera 145 in the device 110 to obtain video images from which the eye position of the user U is extracted. Light (e.g., infrared light) may be reflected from the eye and sensed as video image information by the camera in the device 110. The video image information is then analyzed to extract eye movement information. From the eye movement information, the detection logic 260 determines whether the user U is paying attention to the portion of the display 120.

In one embodiment, the detection logic 260 performs face detection, which is aimed at detecting which direction the user U is looking. For example, the system 200 may make use of the camera 145 in the device 110 to obtain video images from which the face position, expression, etc. information is extracted. Light (e.g., infrared light) may be reflected from the user's face and sensed as video image information by the camera in the device 110. The video image information is then analyzed to extract face detection information. From the face detection information, the detection logic 260 determines whether the user U is paying attention to the portion of the display 120.

In one embodiment, the detection logic 260 performs tremor detection, which is aimed at detecting movement of the device 110 that may be associated with the user U not paying attention to the display 120. For example, the system 200 may make use of the accelerometer in the device 110 to obtain information regarding movement or vibration of the device 110, which may be associated with information indicating that the device 110 is being carried in a pocket or purse. From the tremor detection information, the detection logic 260 determines whether the user U is paying attention to the portion of the display 120.

In one embodiment, the detection logic 260 performs capacitive sensing or heat detection, which is aimed at detecting proximity of the user's body to the device 110 that may be associated with the user U paying attention to the display 120. For example, the system 200 may make use of the capacitive sensing or heat detection to obtain information regarding a user holding the device 110 in his hand or the user U interacting with the display 120. From the capacitive sensing or heat detection information, the detection logic 260 determines whether the user U is paying attention to the portion of the display 120.

In one embodiment, the detection logic 260 detects minimization of an application screen or activation of a screen saver, which is aimed at detecting whether a user U is currently interacting with an application in the device 110. For example, if the user U has minimized a video playing application in the device 110, the detection logic 260 may determine that the user U is not paying attention to the application. Similarly, if a screen saver has been activated in the device 110, the detection logic 260 may determine that the user U is not paying attention to the application.

In other embodiments, the detection logic 260 may make use of other techniques (e.g., galvanic skin response (GSR), and so on) or of combinations of techniques to detect whether the user U is paying attention to the portion of interest in the display 120.

The system 200 further includes a processor 270 that determines a media object to present to the user U of the device 110 from a selection of media objects including media objects of several different media object types based on whether the user U is paying attention to the portion of the display 120. The media objects may be media objects received by the electronic device 110 or media objects retrieved from a memory 280 of the electronic device 110.

For example, the device 110 may play an advertisement video via the display 120. The advertisement video describes a product (e.g., a hamburger) in a combination of video and audio. For example the advertisement video may show the hamburger and a family enjoying the hamburger while a soundtrack plays in the background. However, if the user U is not paying attention to the display 120, the advertisement video is not effective because, being a visual media type object, it is designed to convey a mostly visual content message to the user U. However, in one embodiment of the system 200, once the detection logic 260 has detected that the user U is not paying attention to the advertisement video, the processor 270 determines a media object to present to the user U that is better suited for conveying the content message via other senses other than visual. For example, the processor 270 may determine that an audio media type object associated with the content is better suited to convey the message. In the hamburger example, the processor 270 may determine to present to the user an audio media type object that describes the hamburger in speech and tells the user that his family is welcomed at the hamburger joint. In a traditional media sense, the visual media type object would convey the content message in a “TV-like” manner, while, upon switching, the audio media type object conveys the content message in a “radio-like” manner.

In another example, a live sports event may be video streamed. The video stream shows the action on the field and therefore the play-by-play announcer does not describe the action in nearly as much detail as a radio play-by-play announcer would. However, if the user U is not paying attention to the display 120, the “TV-like” play-by-play is not effective because, being a visual media type object, the video stream is designed to convey a mostly visual content message to the user U. However, in one embodiment of the system 200, once the detection logic 260 has detected that the user U is not paying attention to the advertisement video, the processor 270 determines an audio media type object having a “radio-like” play-by-play to present to the user U that is better suited for conveying the content message.

In yet another example, a TV show (e.g., sitcom, drama, soap opera, etc.) may be optimized with both a visual media type object and an audio media type object associated with the show's content such that if the detection logic 260 detects that the user U is not paying attention to the visual media type object, the processor 270 determines the audio media type object to be presented to the user U that is better suited for conveying the content message.

In summary, in one embodiment, at least two versions of the ad are created: one is a visual media type object for when the user U is paying attention to the display 120 and the other is an audio media type object for when the user U is not paying attention to the display 120. Selection of a media object type in which to present content to the user U of the device 110 may hence be optimized based on the detected state of the user's attention to the display 120.

In one embodiment, the system 200 further includes a text-to-speech logic 290 that receives text data representing a message associated with the content and further configured to transform the text data into the audio media type object or audio forming part of the visual media type object. For example, a voiceover for the hamburger ad is entered by a user as text and the text-to-speech logic 290 transforms the text to speech which then becomes the voiceover in the visual media type object. In another example, the audio media type object for the hamburger ad is entered by a user as text and the text-to-speech logic 290 transforms the text to speech which then becomes the audio media type object that the processor 270 selects when the detection logic 260 detects that the user U is not paying attention to the visual media type object.

In one embodiment, the text-to-speech logic 280 receives the text data representing the message associated with the content in a first language and transforms the text data into speech in a second language different from the first language. In one embodiment, the text data representing the message associated with the content in the first language is first translated to the second language as text and then the second language text is transformed into speech.

Upon the processor 270 determining one of the visual media type object and the audio media type object to present to the user based on the detection logic 260 detecting that the user U is or is not paying attention to the display 120, the determined media object may be played by the device 110 using the display 120, the speaker 125, the headphones 150, or any other corresponding device. In one embodiment, the system 200 achieves real time transition from visual media object type to audio media object type or vice versa by using Real Time Streaming Protocol (RTSP). In other embodiments, protocols such as Real Time Transport Protocol (RTP), Session Initiation Protocol (SIP), H.225.0, H.245, combinations thereof, and so on are used instead of or in combination with RTSP for initiation, control and termination in order to achieve real time or near real time transition from visual media object type to audio media object type or vice versa. The processor 270 instructs the performing of the determined media type object at least in part by transmitting RTSP requests within the device 110 or outside the device 110 such that the performing occurs substantially in real time.

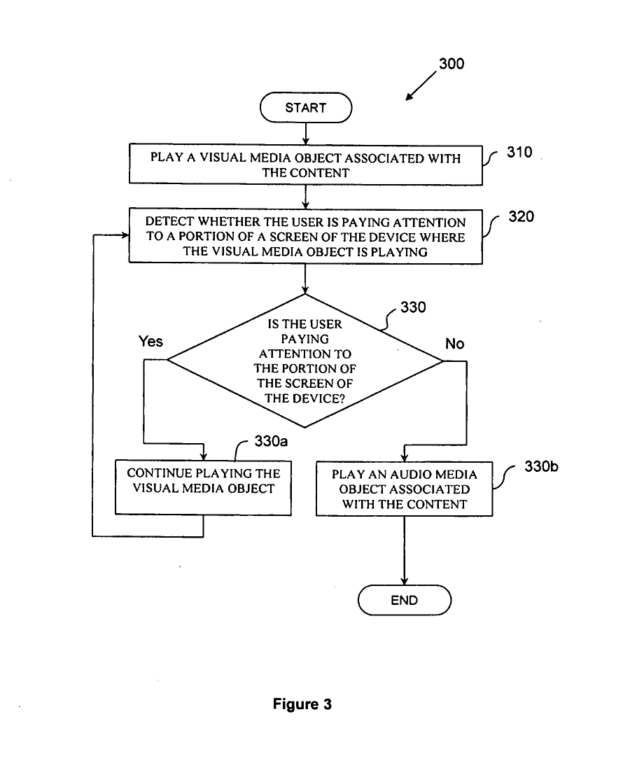

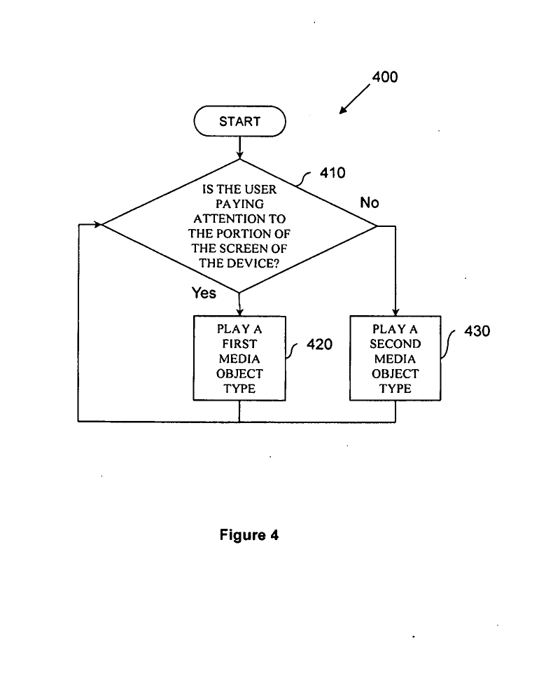

Referring now to FIGS. 3 and 4, flowcharts are shown that illustrate logical operations to implement exemplary methods 300 and 400 for optimizing selection of a media object type in which to present content to a user of a device such as the device 110 discussed above. The exemplary methods may be carried out by executing embodiments of the systems disclosed herein, for example. Thus, the flow charts of FIGS. 3 and 4 may be thought of as depicting steps of methods carried out by the above-disclosed systems. Although FIGS. 3 and 4 show a specific order of executing functional logic blocks, the order of executing the blocks may be changed relative to the order shown. Also, two or more blocks shown in succession may be executed concurrently or with partial concurrence. Certain blocks also may be omitted.

In FIG. 3, the logical flow for optimizing selection of a media object type in which to present content to a user of a device may begin in step 310 by playing a visual media object associated with the content. The visual media object may be a video, an image, graphics, a photograph, television content, a video game, and so on. The visual media object is played on a portion of a screen of the device. At 320, the method 300 further includes detecting whether the user is paying attention to the portion of a screen of the device where the visual media object is playing. The detection may be accomplished by one or more of the detection methods described above such as eye tracking, face detection, and so on.

In one embodiment, in preparation for playing the visual media object associated with the content, the method 300 detects whether the user is paying attention to the portion of the screen of the device, determines whether to play the visual media object based on whether the user is paying attention to the portion of the screen of the device, or determines whether to play the audio media object based on whether the user is paying attention to the portion of the screen of the device.

At 330, the method 300 further includes performing at least one of the following based on whether the user is paying attention to the portion of the screen of the device: 330a) continue playing the visual media object if the user is paying attention to the portion of the screen of the device, or 330b) playing an audio media object associated with the content if the user is not paying attention to the portion of the screen of the device. In one embodiment, the playing the visual media object associated with the content includes playing a video media object associated with the content, or displaying an image media object associated with the content. In one embodiment, the playing the audio media object associated with the content includes playing an audio media object including a spoken-voice message associated with the content, playing an audio media object including a jingle message associated with the content, or playing a soundtrack. In one embodiment, the method 300 further includes transmitting real time streaming protocol (RTSP) requests such that the performing occurs substantially in real time.

In one embodiment, the method 300 further includes receiving text data representing a message associated with the content and transforming the text data into the audio media object or into audio associated with the visual media object. The transformation may be accomplished by one or more text-to-speech modules as described above. In one embodiment, the text data is received in a first language and the transforming the text data into the audio media object type media object includes transforming the text data into the audio media object type media object in a second language different from the first language. In one embodiment, the text data is first translated into text data in the second language and the second language text data is then transformed into the audio media object type media object.

Referring now to FIG. 4, the exemplary method 400 begins at 410 where, in preparation for displaying of a media object, the method 400 detects whether the user is paying attention to a portion of a screen of the device. If the user is paying attention to the portion of the screen of the device, the method 400 continues at 420 where it determines that a first media object type is to be presented to the user from a selection of media objects including media objects of several different media object types based on the user paying attention to the portion of the screen of the device. If the user is not paying attention to the portion of the screen of the device, the method 400 continues at 430 where it determines that a second media object type is to be presented to the user from a selection of media objects including media objects of several different media object types based on the user not paying attention to the portion of the screen of the device. Media object types include visual media objects, audio media objects, and other media object types.

In one embodiment, the method 400 determines a visual media object type to be displayed from the selection of media objects including media objects of several different media object types based on the user being detected paying attention to the portion of the screen of the device. In this embodiment, the method 400 further includes playing a visual media object type media object associated with the content, detecting whether the user is paying attention to a portion of the screen of the device where the visual media object type media object associated with the content is playing, and performing one of the following based on whether the user is paying attention to the portion of the screen of the device where the visual media object type media object associated with the content is playing: 1) continue playing the visual media object type media object associated with the content if the user is paying attention to the portion of the screen of the device where the visual media object type media object associated with the content is playing, or 2) playing an audio media object type media object associated with the content if the user is not paying attention to the portion of the screen of the device where the visual media object type media object associated with the content is playing.

Although certain embodiments have been shown and described, it is understood that equivalents and modifications falling within the scope of the appended claims will occur to others who are skilled in the art upon the reading and understanding of this specification.

1. A method for optimizing selection of a media object type in which to present content to a user of a device, the method comprising:
playing a visual media object associated with the content;
detecting whether the user is paying attention to a portion of a screen of the device where the visual media object is playing; and
performing at least one of the following based on whether the user is paying attention to the portion of the screen of the device:
continue playing the visual media object if the user is paying attention to the portion of the screen of the device, and
playing an audio media object associated with the content if the user is not paying attention to the portion of the screen of the device.

2. The method of claim 1, wherein the detecting whether the user is paying attention to the portion of the screen of the device includes performing at least one of:
eye tracking,
face detection,
tremor detection,
capacitive sensing,
receiving a signal from an accelerometer,
detecting minimization of an application screen,
heat detection,
receiving a signal from a device configured to perform galvanic skin response (GSR), and
detecting whether a screen saver is activated.

3. The method of claim 1, further comprising:
receiving text data representing a message associated with the content; and
transforming the text data into the audio media object.

4. The method of claim 1, wherein the performing comprises:
transmitting real time streaming protocol (RTSP) requests, such that the performing occurs substantially in real time.

5. The method of claim 1, wherein the playing the visual media object associated with the content includes at least one of:
playing a video media object associated with the content, and
displaying an image media object associated with the content.

6. The method of claim 1, wherein the playing the audio media object associated with the content includes at least one of:
playing an audio media object including a spoken-voice message associated with the content,
playing an audio media object including a jingle message associated with the content, and
playing a soundtrack.

7. The method of claim 1, further comprising:
in preparation for playing the visual media object associated with the content, detecting whether the user is paying attention to the portion of the screen of the device;
determining whether to play the visual media object based on whether the user is paying attention to the portion of the screen of the device; and
determining whether to play the audio media object based on whether the user is paying attention to the portion of the screen of the device.

8. A method for optimizing a media object type in which to present content to a user in a device, the method comprising:
in preparation for displaying of a media object, detecting whether the user is paying attention to a portion of a screen of the device; and
determining a media object type to present to the user from a selection of media objects including media objects of several different media object types based on whether the user is paying attention to the portion of the screen of the device.

9. The method of claim 8, wherein the determining determines a visual media object type to be displayed from the selection of media objects including media objects of several different media object types based on the user being detected paying attention to the portion of the screen of the device, the method further comprising:
playing a visual media object type media object associated with the content;
detecting whether the user is paying attention to a portion of the screen of the device where the visual media object type media object associated with the content is playing; and
performing one of the following based on whether the user is paying attention to the portion of the screen of the device where the visual media object type media object associated with the content is playing:
continue playing the visual media object type media object associated with the content if the user is paying attention to the portion of the screen of the device where the visual media object type media object associated with the content is playing, and
playing an audio media object type media object associated with the content if the user is not paying attention to the portion of the screen of the device where the visual media object type media object associated with the content is playing.

10. The method of claim 9, wherein the playing the audio media object type media object includes:
receiving text data representing a message associated with the content; and
transforming the text data into the audio media object type media object.

11. The method of claim 10, wherein the receiving the text data representing the message associated with the content includes receiving the text data in a first language, and the transforming the text data into the audio media object type media object includes transforming the text data into the audio media object type media object, wherein the audio media object type media object is in a second language different from the first language.

12. The method of claim 8, wherein the detecting step includes performing at least one of:
eye tracking,
face detection,
tremor detection,
capacitive sensing,
receiving a signal from an accelerometer,
detecting minimization of an application screen,
heat detection,
receiving a signal from a device configured to perform galvanic skin response (GSR), and
detecting whether a screen saver is activated.

13. The method of claim 9, wherein the performing comprises:
transmitting real time streaming protocol (RTSP) requests, such that the performing occurs substantially in real time.

14. The method of claim 9, wherein the playing the audio media object type media object associated with the content includes at least one of:
playing a first media object including a spoken-voice message associated with the content,
playing a second media object including a jingle message associated with the content, and
playing a soundtrack.

15. A system for optimizing selection of a media object type in which to present content to a user of the device, the system comprising:
a display configured to reproduce visual media type objects associated with the content;
a speaker configured to reproduce audio media type objects associated with the content;
a detection logic configured to detect whether the user is paying attention to a portion of the display; and
a processor configured to determine a media object to present to the user of the device from a selection of media objects including media objects of several different media object types based on whether the user is paying attention to the portion of the display.

16. The system of claim 15, wherein the processor is configured to determine to present or continue to present to the user a visual media type object associated with the content if the user is paying attention to the portion of the display, and wherein the processor is configured to determine to present to the user an audio media type object associated with the content if the user is not paying attention to the portion of the display.

17. The system of claim 16, comprising:
a text-to-speech logic configured to receive text data representing a message associated with the content and further configured to transform the text data into the audio media type object.

18. The system of claim 17, wherein the text-to-speech logic is configured to receive the text data representing the message associated with the content in a first language and to transform the text data into the audio media type object, wherein the audio media object type media object is in a second language different from the first language.

19. The system of claim 15, wherein the detection logic is configured to perform at least one of:
eye tracking,
face detection,
tremor detection,
capacitive sensing,
receiving a signal from an accelerometer,
detecting minimization of an application screen,
heat detection,
receiving a signal from a device configured to perform galvanic skin response (GSR), and
detecting whether a screen saver is activated.

20. The system of claim 15, wherein the processor is configured to instruct the performing of the determined media object at least in part by transmitting real time streaming protocol (RTSP) requests, such that the performing occurs substantially in real time.
